(19) United States
(12) Patent Application Publication
(10) Pub. No.: US 2007/0201086 A1
(43) Pub. Date: Aug. 30, 2007

(54) Method for Sharing Documents Between Groups Over a Distributed Network

(75) Inventors: Sang J. Kim, Morristown, NJ (US); Malcolm A. Smith, Madison, NJ (US)

Correspondence Address: PATENT DOCKET ADMINISTRATOR;LOWENSTEIN SANDLER PC, 65 LIVINGSTON AVENUE, ROSELAND, NJ, 07068, US

(73) Assignee: MOMJUNCTION, INC., Morristown, NJ (US)

(21) Appl. No.: 11/679,908

(22) Filed: Feb. 28, 2007

Related U.S. Application Data
(60) Provisional application No. 60/777,608, filed on Feb. 28, 2006.

(51) Int. Cl. G06F 3/12

(52) U.S. Cl. 358/1.15

(57) ABSTRACT

A technique is disclosed for sending and receiving documents between groups over a distributed computer network, which can include the Internet. The method includes receiving a message which includes a document from a member of a first group, the first message also including an indication of whether the document is send-able to other groups; sending a list of groups to the member of the first group to which the first member belongs if the indication indicates that the document is send-able to other groups; receiving a message which indicates that the document is to be sent to a second group; associating the document with the second group in a database; and storing the document in a database. There is only one version of the document stored in the database at any one time. Users of the method can create a document that is linkable to other groups so that these other groups can see the document without losing a connection to the document. The original user can edit or delete the document and have the changes to the document be reflected in all copies of the document throughout all the groups. The user can allow or prohibit other users to continue to send the document to other groups.

### CROSS-REFERENCE TO RELATED APPLICATIONS

This application claims the benefit of U.S. provisional patent application No. 60/777,608 filed Feb. 28, 2006, the disclosure of which is incorporated herein by reference in its entirety.

### FIELD OF THE INVENTION

The present invention relates generally to distributed communications, and more particularly, to a method for allowing groups of users to communicate with each other across a distributed network.

### BACKGROUND OF THE INVENTION

Since the advent of the Internet, the web has evolved from primarily an electronic publishing system in which companies publish information to web sites for passive consumption by users, to one in which users actively connect to and communicate with each other. Most user-to-user communication via the Internet has been dominated by email, instant messaging, bulletin boards and blogs. Email has become a more formal form of communication and is better suited for one-on-one communication or for information distribution to a group. Email is poorly suited for group discussions. Emails can also be sent in a one-to-many fashion. With bulletin boards, newsgroups, and blogs, messages are posted to a common location for anyone from a selected group to read, and then the readers can post the message back. Bulletin boards better support groups but are designed to be organized by topics, not groups of people. Instant messaging is like email but messages are sent in real time. Blogs are designed for a one-to-many publishing.

All of these traditional tools are ill-suited for group communications on the Internet. People have family, school friends, clubs, or neighborhoods that they belong to. They need tools that enable them to communicate, coordinate, and share information and media amongst people in a group. Moreover, people would greatly benefit if they could access the knowledge of their extended groups, i.e. the groups that the members of their groups belong to and so on. None of the above methods of communicating over the Internet support distributed network communication among extended groups of people.

Non-traditional third-party tools on the market currently do not allow people to both create groups and intelligently move information across groups without having to repost them and losing connection with the original message. Reposting a message to multiple groups can prove highly inefficient. Other problems associated with these third-party tools include the following:
The copies of the messages are not connected.
The author has no control or record of the copies of a message.
The author does not know how many groups to which the message has been reposted
There is a lost opportunity to track and analyze the social networking path through which the message is traveling. This analysis is both beneficial to the users as well as providing valuable word of mouth analysis that can be of great commercial value.

Accordingly, what would be desirable, but has not yet been provided, is a distributed network medium to allow friends, family, clubs, etc., to communicate specifically as a group to other groups in a multi-way fashion.

### SUMMARY OF THE INVENTION

The above-described problems are addressed and a technical solution is achieved in the art by providing a method for sending and receiving documents between groups over a distributed computer network. In some embodiments, the method includes receiving a first message from a member of a first group which includes a document, the first message also including an indication of whether the document is send-able to other groups; sending a list of groups to the member of the first group to which the first member belongs if the indication indicates that the document is send-able to other groups; receiving a message which indicates that the document is to be sent to a second group; and associating the document with the second group. The method also includes storing an association of the document with the second group in a database; storing an association of the second group with the document in the database; and storing the document in a database. There is only one version of the document stored in the database at any one time.

The distributed computer network can be the Internet. In some embodiments, the method is stored on a web-server which is associated with a database server, a notification server, an IP router, and a firewall. The web-server communicates with users over the Internet via a series of web-pages displayed at a plurality of web-enabled terminals. The kinds of documents that can be shared between groups include text, such as email-like messages, files, formatted attachments, calendar events, trading message items, digital photograph, digital video, digital audio, etc.

Users of the method and system can create a document that is linkable to other groups so that these other groups can see the document without losing a connection to the document; edit the original document and have the changes to the document be reflected in all copies of the document throughout all the groups; delete the original document and have all copies of the document be deleted; and allow or prohibit other users to continue to send the document to other groups The author of a document can always send the document to other groups to which they belong. The author can determine whether the document can be sent by other users of a group for which the content was created.

### BRIEF DESCRIPTION OF THE DRAWINGS

The present invention will be more readily understood from the detailed description of exemplary embodiments presented below considered in conjunction with the attached drawings, of which:

FIG. 1 is a block diagram showing the entities involved in a preferred embodiment of the present invention;

FIG. 2 is a block diagram showing several “Rippling” scenarios;

FIG. 3 is a network architecture, constructed in accordance with a preferred embodiment of the present invention;

FIG. 4 is a screen shot for originating a message to be rippled;

FIG. 5 is a screen shot for a user that is receiving a message that has been rippled;

FIG. 6 is a screen shot of a second screen presented to the receiver of a rippled message in which the receiver can also ripple the received message; and

FIG. 7 is a screen shot for deleting a message;

It is to be understood that the attached drawings are for purposes of illustrating the concepts of the invention and may not be to scale.

### DETAILED DESCRIPTION OF THE INVENTION

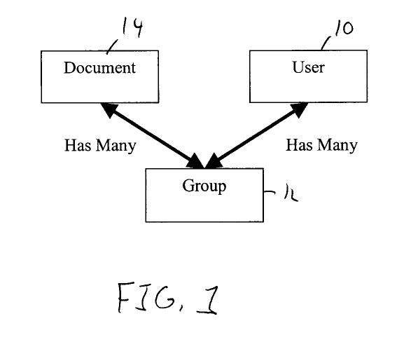

Referring now to FIG. 1, there is shown the entities involved in a preferred embodiment of the present invention, referred to herein as a “Ripple.” A Ripple involves users 10, each of whom is associated with a user name, one or more group names, and an email address. The users 10 belong to one or more groups 12. Typically the users 10 belonging to a group 12 which has some real-world relationship that establishes a level of trust between members of the group 12 (e.g., a family group, friends or a club). As used herein, a “group” is a collection of users 10 identified by a common group ID in a database. A group is a private group when users of the group provide the group ID to subsequent group members by invitation to the group. A group is a public group if its group ID is published in a publicly viewable list, thereby allowing any user to join the group. In effect, the user invites herself to the public group A document 14 can be text, such as an email-like message, a file, or formatted attachment. In addition to basic documents, such as email-like messages, in some embodiments, rippling can also be applied to other types of documents 14 such as Calendar Events, Trading Message items, digital photograph, digital video, digital audio, etc.

Other users 10 outside the group 12 initially do not have access to the documents 14. The embodiments of the invention allow a user 10 to mark one or more documents 14 such that other users 10 in the same group 12 may or may not share the one or more documents 14 with members of other groups 12 to which the users 10 belong. Members of groups 12 to which one or more messages 14 have been sent can in turn propagate these same documents 14 to groups 12 to which these users 10 belong, and so on. Hence, the propagation of documents 14 across groups 12 is referred to herein as a “ripple.” Similarly, the act of propagating documents 14 to other groups 12 is referred to herein as “rippling,” and a document 14 may or may not be “ripple-able” (i.e. send-able). The groups 12 are similar to bulletin boards, except that messages can be shared across the groups 12.

If a document 14 is not marked as “ripple-able,” then only the originating user 10 may share the document 14 with his or her own group 12. Because individual users 10 make a “ripple-able/not ripple-able” decision on a group-by-group basis, the users 10 rely not on rights assigned by a group moderator (not shown) of a computer system (not shown), but on real-world relationships between the members of the group 12. Because of the approach the embodiments of the present invention take, the data collected is a representation of how the documents travels across the groups 12 that direct the paths of the documents 14 and the sequence of their traversals.

With Ripple, the users 10 can create documents 14 to:
link a document 14 to other groups 12 so that these other groups 12 can see the document 14 without losing a connection to the document 14;
edit the original document 14 and have the changes to the document 14 be reflected in all copies of the document 14 throughout all the groups 12;
delete the original document 14 and have all copies of the document 14 be deleted;
allow or prohibit other users 10 to continue to ripple the document 14;
allow the original user 10 to know exactly how many groups 12 and users 10 have access to a document 14;
generate useful analytical data from rippling that can have great commercial value; and;
allow the original user 10 to select useful documents that the user 10 finds in her groups 12 and ripple them to a master group where all useful documents are kept.
   Rippling rules can include the following:
1. The author (user 10) of a document 14 can always ripple a document 14.
2. The author 10 can determine whether the document 14 can be rippled by other users of a group for which the content was created.

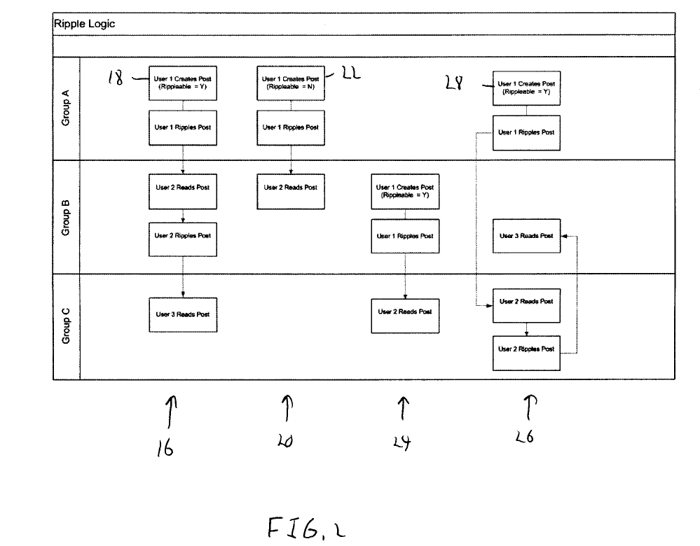

These rules are illustrated in FIG. 2. There are three groups 12: Group A, Group B, and Group C. User 1 belongs to Group A; User 2 belongs to Group B; and User 3 belongs to Group C. In a scenario 16, User 1 creates a document (post) 18. A variable called “ripple-able”, which determines whether the post 18 can be rippled to other groups, is set to Y (for yes). The post 18 is sent to Group B, where User 2 reads the content of the post 18 once User 2 logs into Group B or refreshes her web page. Since the post 18 is ripple-able, User 2 can ripple the post 18 to Group C, where User 3 reads the post 18. In the scenario 20, User 1 creates a post 22, but sets the Ripple-able variable to N (for No). The post 22 is sent to Group B, where User 2 reads the post 22. Since the post 22 is not ripple-able, only members of Group B can read the post 22. The scenario 24 is similar to the scenario 16, except that User 1 is also a member of Group B, and User 2 is also a member of Group C. The scenario 26 is similar to the scenario 18, except User 2 belongs to Group 3 and User 3 belongs to Group 2. User 1 ripples a ripple-able post 28 and sends the post 28 to Group 3, wherein User 3 reads the post 28, and then ripples the post 28 to Group B, wherein User 3 reads the post 28. By default, if the maximum number of degrees of separation is not set, then a post (document) can be infinitely ripple-able. This is the case for the scenarios 18, 20, 24, and 28. Note that a change or deletion made to any of the posts 18, 22, and 28 by User 1 are reflected in the posts read by User 1 and User 3 once User 1 or User 3 refreshes their web page or logs into a group. Note also, for example, in scenario 18, that if User 3 creates a response to the post 18, the response is “rippled” back through Group B and then Group A so that User 1 may review the response.

When a new group is created, the creating user is the first member (user) of the group and may invite any number of other users to join that group by sending “invitations” to other users. These other users, once they become members of a group can in turn invite additional members. The implementation of the creation of a group and how a member of a group invites others to join will be discussed hereinbelow.

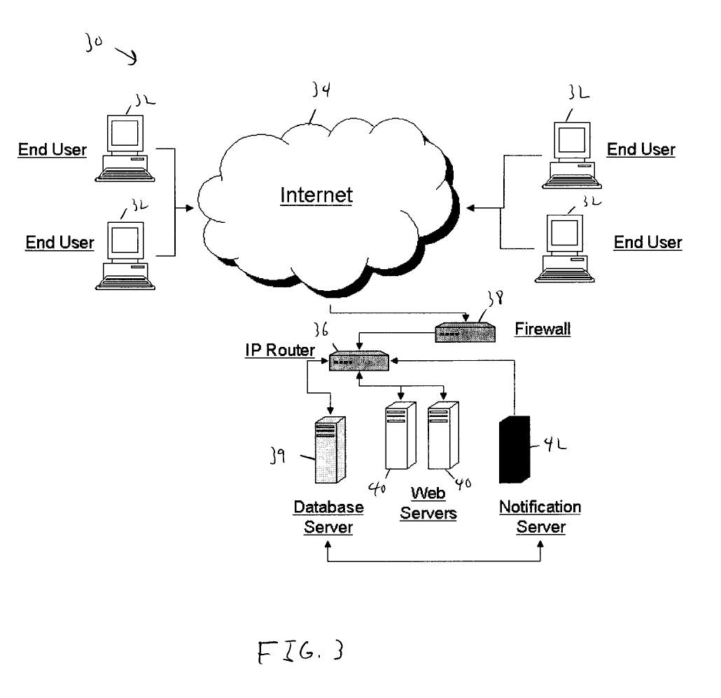

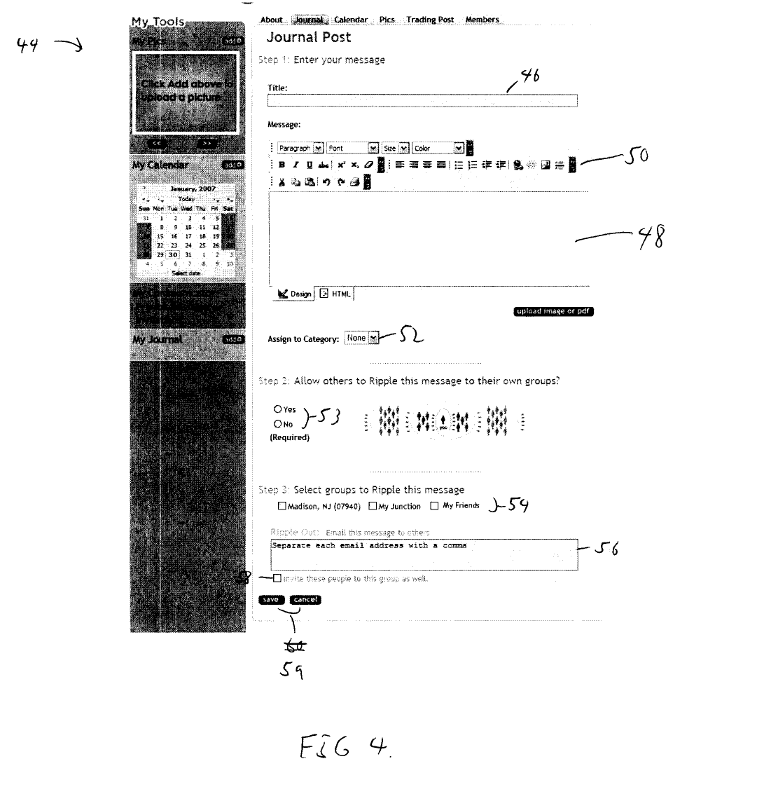

Referring now to FIG. 3, there is shown a distributed network hardware architecture of the preferred embodiment of the present invention, generally indicated at 30. A plurality of users communicate via a corresponding plurality of terminals 32. The terminals 32 can be personal computers, work stations, PDA, smart phones, etc. The terminals 32 are capable of reading a program from memory which presents a plurality of user screens within a web browser, such as Microsoft Internet Explorer®, and which are described below in connection with FIGS. 4-7. The user screens include areas for reading documents of members of a group to which a user belongs, areas for composing documents (post, message, email) that are to be rippled, and buttons and input boxes for collecting user information, such as selecting a group to which to ripple a document. Messages containing rippled documents are associated with source and destination addresses and sent in TCP/IP packets via the Internet 34 through a firewall 36 and an IP router 38 to one or more web servers 40. A message is any information shared between the terminals 32 and the web servers 40, or between servers. A message can comprise a document. In other embodiments, the terminals can communicate with any type of server over any distributed network, including private intranets, local area networks (LANs), wide area networks (WANs), etc. The web-servers 40 have one or more processors, volatile RAM memory, and non volatile memory, such as hard or optical disks and flash memory (all not shown). The one or more processors of the web-servers 40 are capable of reading and executing from memory a server ripple program to be described hereinbelow. The server ripple program is capable of functioning as a main web-site for the ripple service. The web-servers 40 send and retrieve data concerning users, groups, and documents to/from a database server 39 and to/from the web browser programs resident on the plurality of terminals 32. The database server 39 also communicate with a notification server 42. On a periodic basis (including every few minutes, once a day, once a week) the notification server 42 queries the database server 39 to generate a variety of email messages to send to users who request such updates in order to report new activity or changes on the web site associated with the web-servers 40.

The data model stored in the database server 40 and involved in “rippling” are listed below in Tables 1-5. Elements of Tables 1-5 will be referred to in subsequent discussions of the features of Ripple.

TABLE 1
User Member

| Column Name | DataType |
|---|---|
| Memberid | int |
| Username | Nvarchar |
| Lastname | Nvarchar |
| Firstname | Nvarchar |
| address1 | Nvarchar |
| address2 | Nvarchar |
| City | Nvarchar |
| Regioncode | Nchar |
| Countrycode | Nchar |
| Inactive | Bit |
| Creationdt | Datetime |
| Updatedt | Datetime |
| emailaddress | Nvarchar |
| Messagealcode | Nvarchar |
| Referralcode | Nvarchar |

TABLE 2
Group

| Column Name | DataType |
|---|---|
| groupid | int |
| groupname | nvarchar |
| grouptypeid | int |
| groupdescription | nvarchar |
| creationdt | datetime |

TABLE 3
Group Member

| Column Name | DataType |
|---|---|
| groupmemberid | Int |
| roletypeid | Nchar |
| emaildigesttype | Int |
| lastviewdate | Datetime |
| creationdt | Datetime |
| *groupid | Int |
| *memberid | Int |

TABLE 4
Message Document

| Column Name | DataType |
|---|---|
| messageid | Int |
| memberid | Int |
| title | Nvarchar |
| messagebody | Ntext |
| imagepath | Nvarchar |
| thumbpath | Nvarchar |
| creationdt | Datetime |
| updatedt | Datetime |
| viewcount | Int |
| parentid | Int |
| location | Nvarchar |
| contact | Nvarchar |
| isripple-able | Bit |
| degreerule | Int |

TABLE 5
Group Message

| Column Name | DataType |
|---|---|
| groupmessageid | int |
| memberid | int |
| reftypeid | nchar |
| srcgroupid | int |
| creationdt | datetime |
| *groupid | int |
| *messageid | int |

An embodiment of the Ripple web-site associated with the web-servers 40, an example of which can be found at http://www.momjunction.com, contains both private (i.e., unlisted) groups and public (i.e., listed) group. A user becomes a member of a group in one of three ways:
1) Visiting and registering at the web-site associated with the web-servers 40;
2) Creating another group once a member of a group; and
3) Being invited by an existing member of a group.

When visiting the web-site associated with the web-servers 40, the prospective member indicates that she wants to join a web-site associated with the web-servers 40 and is presented with a typical new user registration form as is known in the art. The prospective member is prompted for a user name, password, email address, etc. After filing out the registration form, the new user is given a home group. For example, if the user name were Malcolm, the group created would be called “MalcolmsFriends.” Initially, the user is only member of the “MalcolmsFriends” group and is, of course, invited to his own group. The new group is assigned a Web Address such as http://www.momjunction.com/group/MalcolmsFriends.

For creating another group once a member of the a first group, there will appear on several web pages a button for creating a group. After clicking on the “create a group” button, the user is taken to another web page with a number of fields. The user is asked for the name of the group to be created. The user then fills in a description of the group for people who might join it, such as what is the purpose of the group. Then the user is presented with another web page for inviting other users to the group. The page has an input box for entering email addresses of people the user would like to invite. Then, the user is presented with a sample message that the invitees will be presented with, such as “Malcolm has created a group. He wants to invite you. Here's the information you need to join the group.” The user then clicks the “send invitation button.” At this point the notification server 42, within a predetermined amount of time, say 10 minutes, queries the database for new group invitations, gathers the information, and sends email messages to each email address in the previously entered list. The same invitation procedure is followed for new users who visit the web-site associated with the web-servers 40 for the first time.

When a new user is invited to a group or a current user creates a new group, he receives an email with the group web address and a web link embedded in the email message. Anyone she wishes to invite can receive a forwarded copy of the email and use the link to join the group. When the new user clicks the link, she is presented with a user registration page and after registering, she is added to the GroupMember list for the group and will see the group listed on his own group list in the home page of the web-site.

In addition, a newcomer or current user can subscribe to public groups in a fashion similar to subscribing to Netnews groups or public bulletin boards, as is known in the art.

FIG. 4 depicts an embodiment of a user screen 44 for a user that is originating a message (document). The screen 44 includes a title entry box 46, an entry box 48 for the message to be sent in Step 1. Many formatting operations 50 can be performed in a fashion similar to Microsoft Word®, such as screen fonts. In the pull down menu 52, the user can make an assignment to a category which would group messages together for an alternative view of related messages. In the portion of the screen 44 labeled “Step 2”, two radio buttons 53 are presented to the user for allowing the user to decide whether the message just composed can be rippled by others to members of their respective groups, which may not be one of the groups the current user belongs to. In the portion of the screen labeled “Step 3”, the user selects which groups 54 to which this message is to be rippled (sent). A separate box 56 allows other users at the entered email addresses to receive this message. Another check box 58 invites the users entered in box 56 to become members of the current group to which the user sending the message belongs. Finally, the user sends the message by clicking the “save” button 59.

The following is the algorithm that can be executed by the web-servers 40 for ‘Assigning Ripple Properties’ to a new message that a user creates for displaying to his current group or for rippling to other groups to which he belongs:
1. Create a new object of type Message as msg.
2. Assign current authenticated user to Member property of msg.
3. Assign properties such as message body from Web Page to msg.
4. Assign IsRipple-able property to msg.
5. Create association object of type GroupMesssage as groupmsg.
6. Determine current Group location from Web Page.
7. Create object of type Group as grp.
8. Load grp with values from group table in database by calling Group.FindByGroupName( ) method using current group name from Web Page.
9. Set Group property of groupmsg to grp.
10. Set SrcGroupId property of groupmsg to grp.GroupId.
11. Set Message property of groupmsg to msg.
12. Set RefTypeId to CREATED in groupmsg.
13. Save the msg object to database by calling Session.Save(msg) which also saves all groupmsg association objects.

In summary, to create a new message, a blank message object is created. The current user who created the message is assigned into the member I.D. or the member property of the message. Then the message body, the title, and other fields typical of an email message are assigned to the message object. As shown in FIG. 4, if the user selected that the message is ripple-able, then in step 5 above, an association is made between the message and a selected group to which to ripple the message, i.e., a groupmsg object, by adding a row to the group message table. In step 6, for each group to be associated with a message, i.e., a group for which the message is to be rippled (sent), the current group I.D. is saved. Then the groupmsg associations are created for each ripple-able group beginning with the source group of the message. Then the message and each groupmsg association are saved in the database server 39 (database). Note that there is only one copy of the message (document) stored in the database.

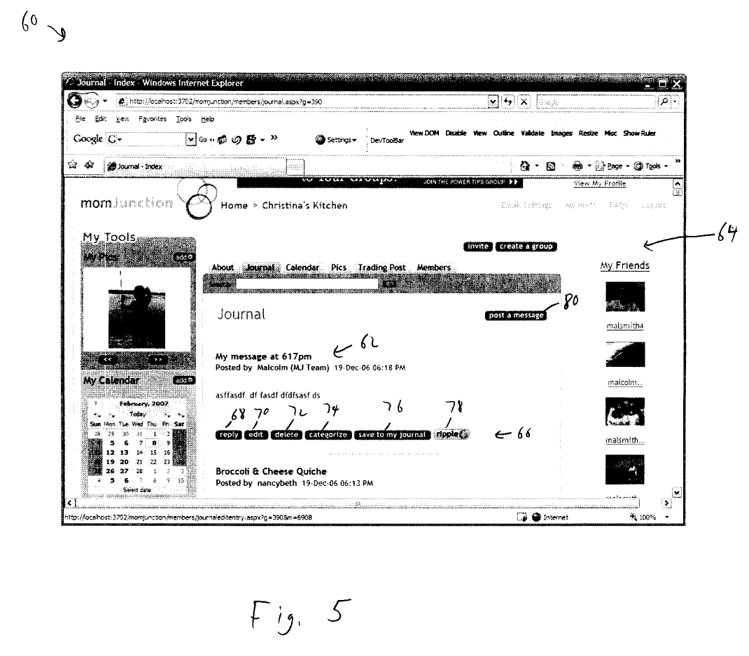

FIG. 5 depicts a user screen 60 for a user that is receiving a message. Each message 62 is displayed in its own area of the screen 64. An array of buttons 66 allow the receiver to enter a reply 68, edit the message 70, delete the message 72, categorize the message 74 into a user defined category name like ‘recipes’ or ‘jokes’, save the message to the user's local journal 76, or ripple the message 78. The upper right corner of the screen 64 is a “post a message” button 80 for sending a new message.

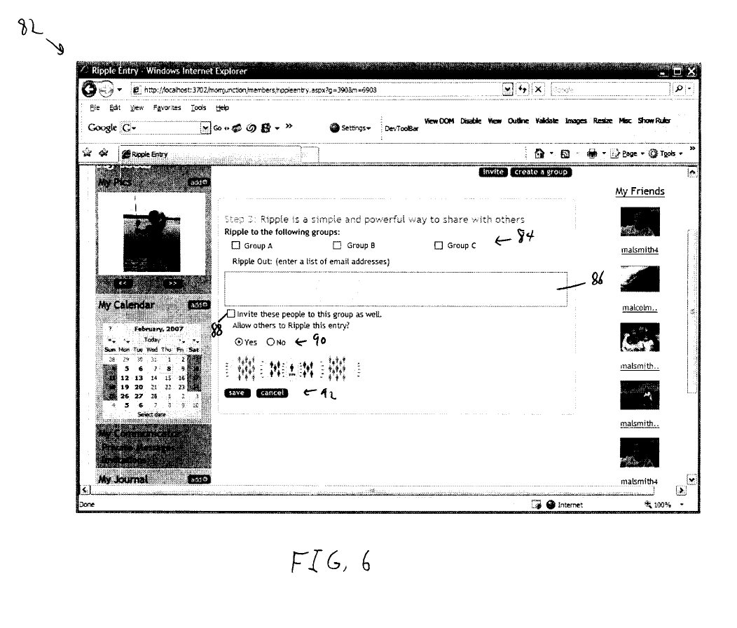

Referring now to FIG. 6, second screen 82 continues the user screen 60. In the second screen 82, the user is presented with check boxes 84 listing all Groups to which the user belongs. A check in one or more of the boxes 84 determines the groups to which a received message will be sent (rippled). An input box 86 allows the user to enter other email addresses to which to send the rippled message for receivers not belonging to one of the groups listed in the check boxes 84. Another check box 88 invites the users associated with the email addresses listed in the box 86 to join the current user's group. The radio buttons 90 allow other users to ripple the received message. Finally buttons 92 allow the user to save or cancel the current set of choices, which itself may result in a ripple of the just received message.

The following is the algorithm executed by the web-servers 40 for “rippling a message to other groups.” This is the algorithm that is executed when the user has clicked the ripple button on a web page that lists messages received in a group in either FIG. 4 or FIG. 6. In the algorithm described below, it is assumed that the user is a member of three other groups (Group A, Group B, Group C):
1. Create object of type Message as msg.
2. Load msg with values from message table in database by calling Session.Load(typeof(Message),msgId). Where msgId is the value provided on the current displayed message.
3. Test if the msg.IsRipple-able value is true otherwise abort the processing and return an error message ‘message may not be rippled.’
4. Load grp with values from group table in database by calling Group.FindByGroupName( ) method using current group name from Web Page.
5. Gather a collection of Group objects from the database by calling Member.GetAllGroupList( ) for the current authenticated Member/User.
6. Present the message details and available group list to the user on a web page (see FIG. 6).
7. If the use clicks the Ripple button on this page continue. Otherwise return to web page showing messages in the group (FIG. 5).
8. If the user selected one or more groups to ‘ripple’ the message to on the web page begin the process from step 9 otherwise return to message list (see FIG. 5).
9. Create a collection of objects of type Group and load each one by calling Group.Load(grpId) where grpid is the value provided from the page Check box form control.
10. For each group object create an object of type GroupMessage as groupmsg. In this loop assign the current group item to an object called curGroup.
11. Assign msg (from step 1) to the Message property of groupmsg.
12. Assign curGroup Group property to the Group property of the groupmsg object.
13. Assign the value RIPPLED to the Reflypeld property of curGroup.
14. Assign the Web Page current Group Id value to the SrcGroupId of the groupmsg object.
15. Associate the groupmsg object with the current Message by calling msg.AddGroupMessage(groupmsg)
16. Repeat until all selected groups are processed.
17. Save the msg object to database by calling Session.Save(msg) which also saves all groupmsg association objects.

In summary, to ripple a new message, a blank message object is created. As shown in FIG. 4, if the user selected that the message is ripple-able, then in steps 4 and 5 above, the available groups for that user are displayed. If the user clicks the ripple button, then an association is made between the message and a selected group to which to ripple the message, i.e., a groupmsg object, by adding a row to the group message table. For each group to be associated with a message, i.e., a group for which the message is to be rippled, the current group I.D. is saved. Then the groupmsg associations are created for each ripplable group beginning with the source group of the message. Then the message and each groupmsg association is saved in the database server 39 (database). Note that there is only one copy of the message stored in the database.

The groups that received the rippled content will see the new entry in their group. The new entry is directly connected to the original entry so that if the author edits or deletes the entry, all the rippled entries will see the edits. “Seeing” a new entry, edited entry, or deleted entry in a group is effected when a user refreshes his web browser screen or logs into a group session. The following is the algorithm executed by the web-servers 40 for ‘Seeing’ or ‘Displaying Messages in a Group’, which include messages belonging to or rippled to a group as well as ‘seeing’ responses to previously posted messages. It is assumed that a user has selected a particular group name from a list of groups that he belongs too. The user is presented with a list of messages in the group according to the rules of this algorithm. Messages are selected according to the following criteria: (See Tables 1-5). <CurrentGroupId> below refers to the primary key value of the Group table corresponding to the group the user selected in the web site's group list page.

| | |
|---|---|
| 1.1.1 | Tables: |
| 1.1.2 | Message table |
| 1.1.3 | GroupMessage table |
| 1.1.4 | |
| 1.1.5 | Where: |
| 1.1.6 | GroupMessage.GroupId value equals <CurrentGroupId> |
| 1.1.7 | Message.MessageId value equals GroupMessage.MessageId |

Then for each message that meets the above criteria, the following is executed:

| | |
|---|---|
| 1. | If the Message.IsRipple-able value is true display the Ripple button |
| | on the message list page for that message item. |
| 2. | If Message.MemberId value is equal to the current authenticated |
| | user's member id show the Edit button and also show the |
| | Delete button on the message list page for that message item. |
| 3. | Retrieve replies to messages in the list by calling the |
| | Message.ReplyMessageList in order to display most |
| | recent reply text and count of total replies. |

When a user has logged in or presses the refresh button, a message is sent to the database to retrieve all messages for a that user in his group. In the database server 39, for each message in the message table, if the group message group I.D. value equals current group I.D. and message I.D. value equals group message, then that message is retrieved and displayed to the user. For each message matching the above criteria, the ripple-able property is checked. If ripple-able is set to true, then the ripple-able button will be displayed for that message. If the message member I.D. is equal to the user's member ID, then the user is presented with the options of editing or deleting the message to be displayed along with the message itself. Any replies to that message are also retrieved and displayed to the user. A list of any replies to that message is retrieved and displayed to the user.

The following is the algorithm executed by the web-servers 40 for “Modifying IsRipple-able Property on an Existing Message.” For the algorithm described below, it is assumed that the user has clicked the edit button on a web page listing messages in his group (See FIG. 5). Note that the Edit button is not visible to a user who is not the original creator of the message object.

| | |
|---|---|
| 1. | Load a object of type Message as msg by calling |
| | Session.Load(currentMessageId) using the |
| | messageId from the message list. |
| 2. | Confirm that the MemberId of msg is equal to the current |
| | user's MemberId. Abort the page loading and return |
| | to the message list if the values are not equal. |
| 3. | Display the values of the message object in the Edit |
| | message web page user interface. |
| 4. | Allow the user to update any values on the web page. If the user |
| | Clicks the Save/Submit button then save object values |
| | to the database by calling Session.Save(msg). |

In summary, a message object corresponding to the message to be edited is loaded into the user's web page from the database, assuming the current user is the creator of that message. The user then changes the message. The message is then saved back to the same row in the database. Saving the message means that there is only one copy of the message in the database. Note that if the user changes the value of the IsRipple-able property, there is no immediate effect on the message or its related data elements in the database. The only effect of a change to IsRipple-able=TRUE is that the message list of any web page of any group containing the message would now include a Ripple button next to the message item. Setting the value of IsRipple-able to FALSE would display the message without a Ripple button. The presence of a Ripple button on a user screen (and subsequent data validation) is the only way a user can initiate a Ripple operation. Note that a change of the value of IsRipple-able for a message does not modify the GroupMessage associations that already exist in the database.

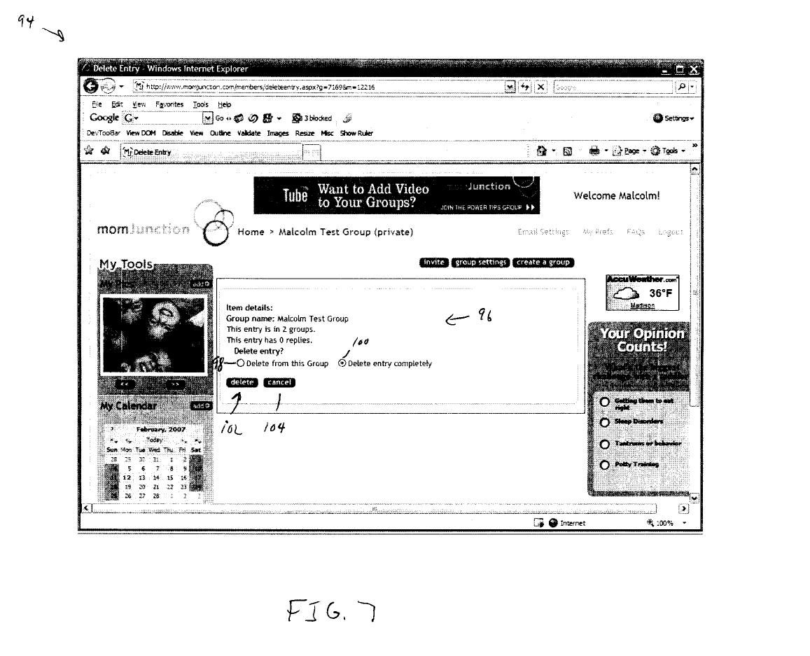

FIG. 7 depicts a user screen 94 for a user that is deleting a message. The user is presented with a list of message details 96, including the group name, the number of groups the current message appears in, and a count of the number of replies to the current message. The user is then presented with a check button 98 for deleting the message from the current croup, and a check button for 100 for deleting the message from all groups. The user this then prompted with a delete the message button 102 or cancel the deletion button 104.

The following is the algorithm executed by the web-servers 40 for “Deleting a Messages in a Group.” (See FIG. 8) For the algorithm listed below, it is assumed that the user has selected a particular message from the message list in a group.

| | |
|---|---|
| 1. | Call Message.Load( ) using the current messageId from the web page to retrieve message |
| | values from the database. |
| 2. | If the current user's memberId value is equal to the MemberId on the message object then |
| | display both the option to delete the message completely from all groups and the option to |
| | delete the message from this group only. |
| 3. | If the current user's memberId is equal to the MemberId on the GroupMessage object |
| | returned by the Message.GetGroupMessageByGroupId(currentGroupId) display the option |
| | to delete the message from this group only. |
| 4. | Begin a database transaction. |
| 5. | If the user chooses to delete the message from all Groups, call the Session.Delete(Message) |
| | to remove all instances of GroupMessage items then delete the message object itself. |
| 6. | If the user selected “delete the message from this group only” then call |
| | Message.GetGroupMessageByGroupId(currentGroupId) to a GroupMessage Object called |
| | grpMsg to get the association object for the current group. Call |
| | Message.GroupMessageList.Remove(grpMsg). Call Session.Save(message) to save the |
| | changes to the database. |

In summary, if the user memberID matches the messages memberID, then that user is the owner of the document. In such circumstances, the user has the option to both delete the message from the current group or from all groups. If the users memberID matches only the current groups memberID (i.e., the user is not the owner of the message), then that user can delete the message only from the current group. If the user is the owner, then both all group message associations and the message row itself is deleted in the database. If the user is not the owner, then only the current group message association is deleted in the database.

The following are algorithms for generating useful analytical data (analytics) provided by the present invention.

Ripple Trajectory

Ripple Trajectory is a 1^{st} order ripple metric that is a measure of the sequence by which a user initiated the ripple mechanism on a message (document) in one group to another group (or set of groups). Each ripple event captures the user, date, time, group from, and current group associated with a given document. To evaluate the Ripple Trajectory, the system queries the database as follows:

| | |
|---|---|
| 1.1.8 | Tables: |
| 1.1.9 | Message table |
| 1.1.10 | GroupMessage table |
| 1.1.11 | |
| 1.1.12 | Where: for a given MessageId |
| 1.1.13 | GroupMessage.GroupId value equals Group.GroupId |
| | “CurrentGroup” |
| 1.1.14 | GroupMessage.SrcGroupId value equals Group.GroupId |

“SourceGroup”

| | |
|---|---|
| 1.1.15 | Message.MessageId value equals GroupMessage.MessageId |
| 1.1.16 | Member.MemberId value equals GroupMessage.MemberId |
| 1.1.17 | |
| 1.1.18 | Return as list of values: |
| 1.1.19 | CurrentGroup.Groupname, SourceGroup.GroupName, |

Member.Name, GroupMessage.CreationDt, Member.MemberId

| | |
|---|---|
| 1.1.20 | |
| 1.1.21 | Order the results by: |
| 1.1.22 | GroupMessage.CreationDt |
| 1.1.23 | |

For example, the results could trace a path for a particular document which would appear at a user terminal as follows:
Document created in Group A by user X at 3 pm
rippled by User Y from Group A to Group B at 3:05 pm
rippled by User Z to Group M and Group N at 9 am next day
   Ripple Audience Volume

Ripple Audience Volume is a 1^{st} order ripple metric that is a measure of the number of potential viewers/readers of a message (document) as it is rippled between groups. To evaluate the Ripple Audience Volume, the system queries the database as follows:

1.1.24 Step 1: Assemble a sequence of groups and creationdt times that the
message appeared in:
1.1.25 Tables:
1.1.26 Message table
1.1.27 GroupMessage table
1.1.28
1.1.29 Where: for a given MessageId
1.1.30 GroupMessage.GroupId value equals Group.GroupId
“CurrentGroup”
1.1.31 Message.MessageId value equals GroupMessage.MessageId
1.1.32
1.1.33 Return as list of values:
1.1.34 CurrentGroup.Groupname, GroupMessage.CreationDt
1.1.35
1.1.36 Order the results by:
1.1.37 GroupMessage.CreationDt
1.1.38 Step 2:
1.1.39 Calculate the total number of users/members of each group in the
sequence.
1.1.40
1.1.41 For each rows in the results returned in Step 1:
1.1.42 count the number of GroupMember rows
1.1.43 Where GroupMember.GroupId = <Results>.GroupId
1.1.44
1.1.45 Return a list of:
1.1.46 CreationDt, GroupName, Count of Members of Group

The results of the above query can show a Ripple Audience for a particular document on the screen of a terminal. Assuming that Group A has 30 users, Group B has 45 users, Group M has 25 users and Group N has 100 users, the terminal screen would show:
Group A at 3 pm, message can be viewed by 30 users
Group B at 3:05 pm, message can be viewed by an additional 45 users
Group M, Group N at 9 am next day, message can be viewed by an additional (25+100) 125 users.
   Changes in Ripple Metric Factors over a Period of Time

For each of the 1^{st} order ripple metrics, there are 2^{nd} order analytics that measure the change in Ripple Velocity or Ripple Audience Volume over time. By measuring how quickly or how far a message is rippled (using Ripple Trajectory), the present invention provides a critical measurement of the urgency of the document which is a proxy for “word of mouth”. Alternatively, measuring the change in audience volume is a proxy for the popularity of the document contents.

Cross Reference User Profile Information Against Ripple Metrics

Each user of the system also provides a selection of typical demographic information (city, zip code) as well as optionally provided information on age, family composition, interests, hobbies etc. Furthermore, each user may join groups that are themselves interest, topic or affinity based (e.g., Gardening Group, New Mothers Group). By combining demographic factors and/or affinity factors with the Ripple Trajectory metric, the present invention provides a unique insight into the motivations behind the user's decision to ripple. To evaluate the User Profile Data against Ripple Trajectory the system queries the data as follows:

1.1.47 Tables:
1.1.48 Member table where Member.MemberId =
results.Member.MemberId
1.1.49 Results of Ripple Trajectory:
1.1.50 CurrentGroup.Groupname,
SourceGroup.GroupName, Member.Name
1.1.51 Member.MemberId, GroupMessage.CreationDt
1.1.52
1.1.53 For each row of the results above:
1.1.54 Select MemberDemographic elements for the ‘rippler’
memberid.
1.1.55
1.1.56 Calculate count of demographic elements for all rows of results.

For example, the results of this algorithm can show at a user terminal the following:

Document created in Group A by user X at 3 pm—User X lives in Madison, Wis. age 35 with 1 child.

rippled by User Y from Group A to Group B at 3:05 pm—User Y lives in Madison, Wis. age 30 with 2 children.

rippled by User Z to Group M and Group N at 9 am next day—User Z lives in Madison Wis. age 35 with 3 children.

The system would summarize the results as:

For Document XXX—for 3 ripplers:

Madison Wis. (3),
Age 30 (1), Age 35 (2)
Children (1), Children (2), Children (3)
   An analyst may conclude that the document was of particular interest to residents of Madison Wis. between ages 30-35 and who had children.
   Cross Reference Group Member Profile Information Against Ripple Metrics

By combining demographic factors and/or affinity factors with the Ripple Trajectory metric, an analyst is provided with a unique insight into the popularity of a particular document. For example, to evaluate the Group Profile Data against Ripple Trajectory, the system queries the database as follows:

1.1.57 Tables:
1.1.58 GroupMember where GroupMember.MemberId =
results.Member.MemberId
1.1.59 Member table where GroupMember.MemberId =
Member.MemberId
1.1.60 Results of Ripple Trajectory:
1.1.61 CurrentGroup.Groupname,
SourceGroup.GroupName, Member.Name
1.1.62 Member.MemberId, GroupMessage.CreationDt
1.1.63
1.1.64 For each row of the results above:
1.1.65 Select MemberDemographic elements for the Group Member
1.1.66
1.1.67 Calculate count of demographic elements for all rows of results

For example, the results of this algorithm can show at a terminal screen the following:
Group A at 3 pm, message can be viewed by 30 users—20 Users are residents of Madison Wis., 10 Users are residents of Boise Id., 15 users have 2 children, 15 users have 1 child. Age 30 (10) Age 35 (20)
Group B message can be viewed by an additional 45 users, Users, 30 Users are residents of Madison Wis., 15 Users are residents of Brooklyn N.Y., Age 25 (25) Age 30 (5), Age 35 (15), 40 have 2 children, 5 have no children.
Group M (25 users)—10 users are residents of Brooklyn, 15 are residents of Madison Wis. 25 Users have 2 children. Age 35 (25)
Group N 100 users—50 users have 2 children 50 user have 3 children. All live in Madison Wis. Age 30 (50) Age 35 (50).
   The system would summarize the results as:
   For Document XXX—for total of 200 audience members:

Madison Wis.(165)

Age 25 (25), Age 30 (65), Age 35 (115)

No children (5), 1 Child (15), 2 Children (130), 3 Children (50)

An analyst may conclude that the document was of particular interest to residents of Madison Wis. between ages 30-35 and who had children.

It is to be understood that the exemplary embodiments are merely illustrative of the invention and that many variations of the above-described embodiments may be devised by one skilled in the art without departing from the scope of the invention. It is therefore intended that all such variations be included within the scope of the following claims and their equivalents.

What is claimed is:

1. A method for sharing documents between groups over a distributed network, comprising the steps of:
receiving a first message from a member of a first group comprising a document, said first message also comprising an indication of whether the document is send-able to other groups to which the first member belongs;
sending a list of groups to the member of the first group to which the member belongs if the indication indicates that the document is send-able to other groups;
receiving a message which indicates that the document is to be sent to a second group; and
associating the document with the second group.

2. The method for sharing documents of claim 1, further comprising the step of storing an association of the document with the second group in a database.

3. The method for sharing documents of claim 1, further comprising the step of storing an association of the second group with the document in the database.

4. The method for sharing documents of claim 2, further comprising the step of storing the document in a database.

5. The method for sharing documents of claim 4, wherein said step of sending a list of groups to the member of the first group further comprises the step of sending properties of the document to the member of the first group.

6. The method for sharing documents of claim 2, wherein the document is one of a text message, file, and formatted attachment.

7. The method for sharing documents of claim 2, wherein the document is one of an email-like message, calendar event, trading message items, digital photograph, digital video, and digital audio.

8. The method for sharing documents of claim 4, further comprising the steps of:
receiving a message from a member of the second group which indicates that all documents associated with the second group are to be retrieved;
retrieving a list of documents associated with the second group; and
sending a copy of the document to the member of the second group.

9. The method for sharing documents of claim 8, further including the step of retrieving information associated with the document from the database, said information indicating that the document is send-able to other groups, wherein said step of sending a copy of the document to the member of the second group further includes the step of sending an indication to display that the document is send-able.

10. The method for sharing documents of claim 9, wherein the message received indicates that the member of the second group is the owner of the document, and wherein said step of sending a copy of the document further comprises the step of sending an indication to display that the document is editable and the step of sending an indication to display that the document is delete-able.

11. The method for sharing messages of claim 4, further comprising the steps of:
receiving a reply from the member of the second group;
associating the reply with the first group;
storing the reply in the database;
receiving a message from the member of the first group which indicates that all documents and replies for the first group are to be retrieved; and
sending the reply to the member of the first group.

12. The method for sharing messages of claim 4, further comprising the steps of:
receiving a message from the member of the first group which contains an indication that the document is send-able;
saving the indication in the database;
sending an indication to the member of the first group to display that the document is send-able.

13. The method for sharing messages of claim 12, further comprising the steps of:
receiving message from the member of the first group which contains an indication that the document is not send-able;
saving the indication in the database;
sending an indication to the member of the first group to remove an indication that the document is not send-able.

14. The method for sharing messages of claim 13, further comprising the steps of:
receiving a message from the member of the second group which indicates that all documents associated with the second group are to be retrieved;
retrieving a list of messages associated with the second group, the list excluding the document; and
sending the messages associated with the second group to the member of the second group.

15. The method for sharing messages of claim 4, further comprising the steps of:
receiving a message from the member of the first group which indicates that the document is to be deleted;
confirming that member of the first group is the owner of the document;
deleting the association of the document with the second group in the database; and
deleting the document from the database.

16. The method for sharing messages of claim 15, further comprising the steps of:
receiving a second message from the member of the second group which indicates that all documents associated with the second group are to be retrieved;
retrieving a list of messages associated with the second group, the list excluding the document; and
sending the list of messages associated with the second group to the member of the second group.

17. The method for sharing messages of claim 4, further comprising the steps of:
receiving a message from the member of the second group which indicates that the document is to be deleted;
confirming that member of the second group is not the owner of the document; and
deleting the association of the document to the second group in the database.

18. The method for sharing messages of claim 17, further comprising the steps of:
receiving a second message from the member of the second group which indicates that all documents associated with the second group are to be retrieved;
retrieving a list of messages associated with the second group, the list excluding the document; and
sending the list of messages associated with the second group to the member of the second group.

19. The method for sharing messages of claim 4, further comprising the steps of:
receiving a message from the member of the first group which includes a request to retrieve documents from a public group; and
sending a document from the public group to the member of the first group.

20. The method for sharing messages of claim 1, wherein the second group is a private group.

21. An apparatus for sharing documents between groups over a distributed network, comprising of:
a web-server:
for receiving a first message from a member of a first group containing a document, said first message also containing an indication of whether the document is send-able to other groups;
for sending a list of groups to the member of the first group to which the first member belongs if the indication indicates that the document is send-able to other groups;
for receiving a message which indicates that the document is to be sent to a second group; and
for associating the document with the second group; and
a database server:
for storing an association of the document with the second group;
for storing an association of the second group with the document in the database; and
for storing the document in a database.

22. The apparatus for sharing documents of claim 21, wherein the distributed network is the Internet and further comprising:
an IP router for routing messages between the Internet and the web-server;
a firewall for protecting said web-server from unwanted messages; and a notification server for querying the database server on a periodic basis to generate messages to send to users in order to report new activity or changes on the web site associated with the web-servers.

23. The apparatus for sharing documents of claim 22, wherein said notification server queries the database for a list of new group invitations and sends email messages to each email address in the list.

24. A method for sharing documents between groups over a distributed network, comprising the steps of:
receiving a message from a member of a first group which indicates that all messages associated with the first group are to be retrieved;
sending at least one document associated with the first group to the member of the first group;
sending an indication to the member of the first group that the at least one document is send-able to at least a second group to which the member belongs;
sending a list comprising the second group to the member of the first group;
receiving a message which indicates that the document is to be sent to the second group; and
sending a copy of the document to the second group.

25. The method for sharing messages of claim 24, wherein the list comprising the second group is a plurality of groups.

26. The method for sharing messages of claim 25, further comprising the step of sending the message to the plurality of groups.

27. The method for sharing messages of claim 24, further comprising the steps of:
receiving a message from a member of the second group which indicates that all messages associated with the second group are to be retrieved;
sending the least one document to the member of the of second group;
sending an indication to the member of the second group that the at least one document is send-able to a list comprising a third group to which the member of second group belongs, said member of the first group not being a member of the third group;
sending a list containing the third group to the member of the of the second group;
receiving a message which indicates that the at least one document is to be sent to the third group; and
sending a copy of the document to the third group.

28. The method for sharing documents of claim 24, further comprising receiving a message that indicates that the member of the second group is the owner of the document, and wherein said step of sending a copy of the document further comprises the step of sending an indication to display that the document is editable and the step of sending an indication to display that the document is delete-able.

29. The method for sharing messages of claim 24, further comprising the steps of:
receiving a reply from the member of the second group;
receiving a message from the member of the first group which indicates that all documents and replies for the first group are to be retrieved; and
sending the reply to the member of the first group.

30. The method for sharing messages of claim 24, further comprising the steps of:
receiving a message from the member of the first group which contains an indication that the document is send-able;
sending an indication to the member of the first group to display that the document is send-able.

31. The method for sharing messages of claim 30, further comprising the steps of:
receiving message from the member of the first group which contains an indication that a second document is not send-able to a second group;
sending an indication to the member of the first group to remove an indication that the second document is not send-able to the second group;
receiving a message from a member of the second group containing an indication to retrieve all documents associated with the second group; and
sending a list of documents associated with the second group, the list excluding the second document to the member of the second group.

32. The method for sharing messages of claim 24, further comprising the steps of:
receiving a message from the member of the first group which indicates that the document is to be deleted;
confirming that member of the first group is the owner of the document;
receiving a second message from the member of the second group which indicates that all documents associated with the second group are to be retrieved;
retrieving a list of messages associated with the second group, the list excluding the document; and
sending the list of messages associated with the second group to the member of the second group.

33. The method for sharing messages of claim 28, further comprising the steps of:
receiving an edited version of the first document from the member of the second group;
receiving a message which indicates that the first document is to be sent to a member of the first group; and
sending a copy of the edited version of the first document to the member of the first group.

34. The method for sharing messages of claim 24, further comprising the steps of:
receiving a message from a web page link indicating the member of the first group is invited to join a third group;
recording in the database that the member of the first group is a member of the third group;
receiving a message of the member of the first group to retrieve all messages associated with the third group; and
sending at least one message associated with the third group to the member of the first group.

35. The method for sharing documents of claim 24, further comprising the steps of:
receiving a message from the member of the first group to retrieve a Ripple Trajectory of the first message;
sending the Ripple Trajectory of the first message to the member of the first group.

36. The method for sharing documents of claim 24, further comprising the steps of:
receiving a message from the member of the first group to retrieve a Ripple Audience Volume of the first message;
sending the Ripple Audience Volume of the first message to the member of the first group.
